(19) United States
(12) Patent Application Publication
(10) Pub. No.: US 2004/0016880 A1
(43) Pub. Date: Jan. 29, 2004

(54) Method for the preparation of a TEM lamella

(75) Inventors: Joachim Reiner, Kilchberg (CH); Philippe Gasser, Zurich (CH)

Correspondence Address: WEBB ZIESENHEIM LOGSDON ORKIN & HANSON, P.C., 700 Koppers Building, 436 Seventh Avenue, Pittsburgh, PA, 15219-1818, US

(73) Assignee: EMPA Eidg. Materialprufungs- und Forschungsanstalt, Dubendorf (CH)

(21) Appl. No.: 10/414,422

(22) Filed: Apr. 15, 2003

(30) Foreign Application Priority Data
Apr. 18, 2002 (CH) 0661/02

(51) Int. Cl. G01N 23/04; G01N 1/28

(52) U.S. Cl. 250/307; 250/304

(57) ABSTRACT

The method relates to the preparation of a TEM lamella from a structured sample, in particular of a microelectronic device, which has a location to be examined, situated at an unknown position. Firstly, the structural element within which the region to be examined is situated is prelocalized. Afterwards, the TEM lamella is sectioned by means of an ion beam of an FIB apparatus with a thickness such that the entire structural element is contained in the TEM lamella. This method considerably increases the probability that the location to be examined will actually be situated in the TEM lamella, without the sample or lamella having to be transported too often.

### TECHNICAL FIELD

The invention relates to a method for the preparation of a TEM lamella. TEM lamellae of this type are suitable in particular for examining defects in integrated circuits.

### PRIOR ART

Transmission electron microscopes are used for the analysis and physical characterization of materials, in particular for the defect analysis of microelectronic devices such as semiconductor components. This physical analysis of local defects included in the material, such as a gate oxide breakdown, for example, is important for understanding the processes in the materials.

In order to obtain a good image, the samples to be analysed are prepared in the form of TEM lamellae having a typical thickness of 0.1 μm. The TEM lamellae are usually prepared by means of local material removal using a fine ion beam of an FIB apparatus (FIB=Focused Ion Beam) or a two-beam apparatus. In the two-beam apparatus, an FIB apparatus is combined with a scanning electron microscope SEM. In this case, the SEM beam is incident at a different angle but on the same location of the sample, so that, without changing the position of the sample, the latter can alternately be prepared by means of the FIB beam and be examined by means of the SEM beam. An apparatus of this type is described for example in U.S. Pat. No. 5,525,806.

Various types of lamellae can be produced. In a first case, a section is made parallel to the surface of the sample. So-called SAPTEM lamellae (SAP=specific area planar sectioning) are obtained. In another case, a cross section of the sample is produced. This lamella is called a SAXTEM lamella (SAX=specific area cross sectioning). Methods for producing such TEM lamellae by means of an FIB beam are described for example in S. Subramanian et al., “A Selected Area Planar TEM (SAPTEM) Sample Preparation Procedure for Failure Analysis of Integrated Circuits”, Proceedings from the 24th International Symposium for Testing and Failure Analysis, 1998, pages 131-135, and in R. M. Langford et al., “Cantilever technique for the preparation of cross sections for transmission electron microscopy using focused ion beam workstation”, J. Vac. Sci. Technol. B 18(1), January/February 2000, pages 100-103.

A TEM examination of a defect or of another locally delimited region necessitates the preparation of a TEM lamella which actually contains the site of interest. If the defect or the region is very small, then prelocalization with an accuracy of less than 50 nm is necessary. Methods for such accurate prelocalization do not exist in practice. Although in the prior art prelocalizations are carried out by means of emission microscopy, potential contrast methods or OBIRCH, they do not achieve the said accuracy. In addition, the lamella has to be positioned with the same accuracy of approximately 50 nm on the sample, which again is not easy.

By way of example, a gate oxide breakdown in a CMOS transistor often exhibits local light emission when voltage is applied. As a result, it is possible to localize the location using emission microscopy with a spatial resolution of approximately 1 μm. Given a lamella thickness of 0.1 μm (100 nm), the probability of the defect subsequently being situated in the lamella is about 1:10. It is thus not impossible, but it is very complicated, to examine such small defects in the transmission electron microscope TEM.

Jon C. Lee et al., “A Novel Application of the FIB Lift-out Technique for 3-D TEM Analysis”, Microelectronics Reliability 41 (2001), pages 15511556, proposes using the TEM for the prelocalization of very small damage. For this purpose, firstly a SAPTEM lamella is produced, the latter is examined in the TEM and the defect is localized. Afterwards, a SAXTEM lamella is sectioned from the SAPTEM lamella, said SAXTEM lamella comprising the defect with a high degree of probability. Said SAXTEM lamella is placed into the TEM again in order now to examine the defect. The fact that the sample or the lamella has to be processed twice in the FIB apparatus is disadvantageous. The handling of these very small samples and lamellae is extremely difficult, however, so that the lamellae are often damaged while they are being handled. In addition, this method presupposes that the plane in which the defect is situated is known. In addition, this method cannot be employed in many cases. This is because the said method encounters its limit if the location of interest is very small or if it is covered by a material which makes observation more difficult. Gate oxide damage may be very small in the case of modern CMOS technologies, which can have a gate oxide thickness of far less than 10 nm. In the extreme case, it comprises an atomic point defect, as is presumed in the case of the so-called “soft breakdown”. The above-mentioned method is unsuitable for this purpose because the damage is covered by polysilicon, which, moreover, can still be silicided in modern technologies. Due to the image of the irregular polycrystalline structure of the polysilicon, the image of a small defect is concealed, and reliable localization is no longer possible.

### SUMMARY OF THE INVENTION

Therefore, it is an object of the invention to provide a method for the preparation of a TEM lamella from a sample which increases the probability that a location to be examined will be situated in the lamella, and which nevertheless avoids multiple handling of the sample or lamella.

This object is achieved by means of a method having the features of Patent claim 1.

In the method according to the invention, firstly the structural element of the sample in which the location to be examined is situated is localized. Afterwards, the TEM lamella is sectioned with a thickness such that the entire structural element is contained in the TEM lamella.

In traditional samples, the TEM lamella thus has a greater thickness than the 100 nm customary hitherto. It has been shown, however, that the resolution of the transmission electron microscope suffices to enable a sufficient analysis of the region to be examined even with lamellae having such a thickness.

The method according to the invention is suitable in particular for defect analysis in microelectronic devices, in particular for the examination of CMOS transistors. However, it is not limited thereto.

Further advantageous variants of the method emerge from the dependent patent claims.

### BRIEF DESCRIPTION OF THE DRAWING

The subject-matter of the invention is explained below using a preferred exemplary embodiment illustrated in the accompanying drawing, in which:

FIG. 1 shows a longitudinal section through part of a CMOS transistor for producing a TEM lamella in accordance with the prior art;

FIG. 2 shows a longitudinal section through part of a CMOS transistor for producing a TEM lamella in accordance with the method according to the invention, and

FIG. 3 shows a view of a TEM lamella with a defective location contained therein.

### WAYS OF EMBODYING THE INVENTION

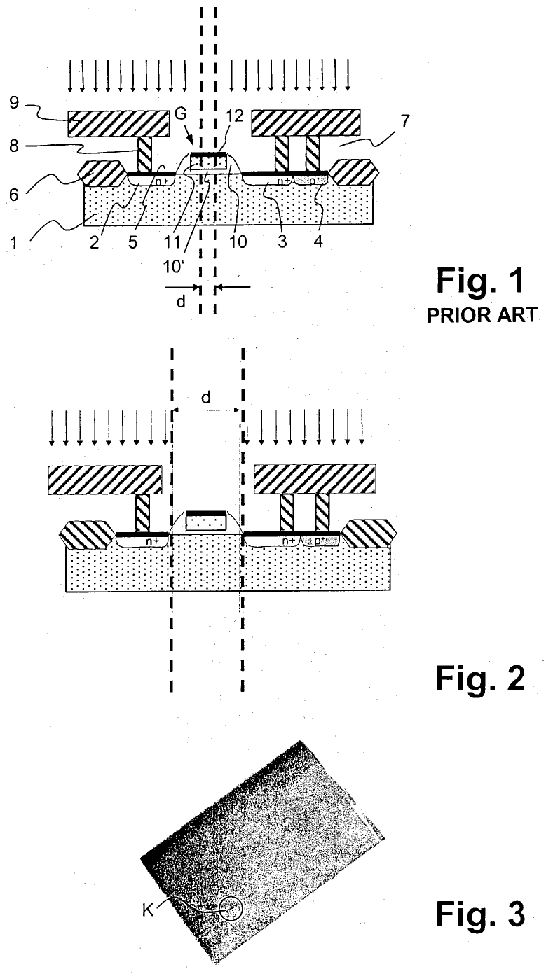

Part of a semiconductor component is illustrated as a sample in FIG. 1. What is involved is a CMOS transistor of known construction. Various zones are doped in a silicon substrate 1: an n⁺-type zone 2 for a drain, an n⁺-type zone 3 for a source and a p⁺-type zone 4 for a substrate contact. The zones are covered with a silicide layer 5 bounded by LOCOS layers 6 on both sides. Above the silicide layer 5 there is a silicon dioxide layer 7, through which tungsten contacts 8 penetrate. The tungsten contacts 8 make contact with metal layers 9 of the source and drain terminals. Between source and drain there is a gate G, which is arranged on a gate oxide layer 10′ and is bounded by a spacer 10 made of silicon dioxide. The gate G essentially comprises a polysilicon layer 11 covered with a silicide layer 12. The FIB beam used for producing a SAXTEM lamella is illustrated by arrows in FIG. 1. The broken lines represent the section lines for the lamella. As can be seen in FIG. 1, in the prior art the lamella is sectioned relatively thin, so that only part of the gate G is contained therein. Typical thicknesses d are 100 nm.

The method according to the invention can now be described with reference to FIG. 2. A semiconductor device with the same structuring as in FIG. 1 has been illustrated as an example. However, the method according to the invention is not limited to such devices or structures.

In the method according to the invention, firstly a location to be examined, or a region, for example a defect, is prelocalized as accurately as possible. In other words the structural element of the structured sample in which the location is situated is determined. The said structural element is the gate G in the example illustrated here.

This prelocalization can be carried out by means of known methods such as, for example, emission microscopy, electrical measurement of the sample or combinations thereof. In integrated circuits, knowledge of the circuit topology is preferably used, moreover. In the integrated circuit, it is generally possible to localize the defect to an extent such that the active element (e.g. transistor) in which it is situated is known. By way of example, if a gate leakage current is located in a transistor having a plurality of fingers, the finger in which the said current occurs has to be determined by other methods, some of which are not electrical.

Afterwards, a TEM lamella, preferably a SAXTEM lamella, is sectioned by means of an FIB apparatus. Other suitable apparatuses for sectioning the TEM lamella can likewise be used. In this case, the TEM lamella has a thickness, and is positioned, such that it contains the entire prelocalized structural element in which the location to be examined is presumed to be situated. In the example illustrated here, the lamella thus contains the entire gate G or the entire transistor finger. This ensures that the location to be examined is actually situated in the TEM lamella. FIG. 3 illustrates a view of the lamella. The circle K therein designates the position of the location to be examined, or of the defect. The defect itself is not discernible at this resolution.

The thickness or width of the TEM lamella may therefore be more than 100 nm, depending on the structural elements. In traditional semiconductor components, they are thicker than 250 nm and may perfectly well have values of approximately 500 nm. In modern and especially in future technologies, however, the structural elements are often significantly smaller than 250 nm, so that in these cases the lamella is also certainly relatively narrow. Therefore, the method presented is suitable in particular, but not exclusively, for modern and future technologies with very small structures.

During the preparation of the lamella, care is preferably taken to ensure that the prelocalized structural element is not damaged. In the example illustrated here, the lamella is sectioned such that its lamella surfaces lie parallel to the longitudinal side of the gate G and are at a sufficient distance from the polysilicon layer 11 of the gate G which prevents the gate G from being damaged. The distance is typically approximately 50 nm.

The material removal by means of the FIB beam is ended, according to the invention, before the prelocalized structural element has been reached. Therefore, in a preferred variant of the method, readily discernible structural elements are taken into account which are arranged adjacent to the prelocalized structural element. These are observed during the material removal or between individual removal steps. This can already be discerned in the image of the FIB beam, depending on the type of structural element. The two-beam apparatus mentioned in the introduction is preferably used for this purpose, however. In the example illustrated here, the tungsten contacts are readily discernible structural elements of this type. However, there may also be other structural elements which, for example, are composed of a different material from the prelocalized structural element. By way of example, it is possible to use the silicide layer 5 on the diffusion zones 2, 3.

A prerequisite for the orientation towards adjacent structural elements is knowledge of the cross section of the structural element to be examined and of its surroundings. In the case of samples with an unknown construction, in a preferred variant of the method, use is made of a reference sample which has the same structuring as the sample to be examined. From this reference sample, a cross section, preferably a SAPTEM lamella, is produced. Preferably, the FIB apparatus is likewise used for this purpose. The structural elements of interest in the reference sample are then detected and localized by means of the SEM or another suitable apparatus.

The method according to the invention thus considerably increases the probability that the region to be examined will actually be situated in the TEM lamella, without the sample or lamella having to be transported too often.

### List of Reference Symbols

d Thickness of the TEM lamella

G Gate

K Circle

1 Silicon substrate

2 n⁺-type zone of the drain

3 n⁺-type zone of the source

4 p⁺-type zone of the substrate contact

5 Silicide layer

6 LOCOS layer

7 Silicon dioxide layer

8 Tungsten contact

9 Metal layer

10 Spacer

11 Polysilicon layer

12 Silicide layer

1. Method for the preparation of a TEM lamella from a structured sample, in particular of a microelectronic device, the sample having a location to be examined, situated at an unknown position, for the purpose of examining the TEM lamella in a transmission electron microscope (TEM), the TEM lamella being sectioned from the sample, wherein the structural element within which the location to be examined is situated is prelocalized, and wherein the TEM lamella is sectioned with a thickness such that the entire prelocalized structural element is contained in the TEM lamella.

2. Method according to claim 1, wherein the TEM lamella is sectioned by means of an ion beam of an FIB apparatus.

3. Method according to claim 1, wherein sample is sectioned in cross section, thereby producing a SAXTEM lamella.

4. Method according to claim 1, wherein the TEM lamella has a thickness which is insignificantly greater than the width of the prelocalized structural element.

5. Method according to claim 1, wherein a TEM lamella is sectioned which is thicker than 100 nm, in particular thicker than 250 nm.

6. Method according to claim 1, wherein a TEM lamella is sectioned which has a thickness of approximately 500 nm.

7. Method according to claim 1, wherein a cross section is produced before the sectioning of the TEM lamella at a reference sample with identical structuring, for the purpose of identifying the individual structural elements.

8. Method according to claim 1, wherein before the sectioning of the TEM lamella, a suitable structural element is determined in the presumed region of the location to be examined.

9. Method according to claim 1, wherein observable structural elements which are arranged in the sample adjacent to the structural element comprising the location to be examined are taken into account during the sectioning of the TEM lamella.

10. Method according to claim 8, wherein the observable structural elements are observed by means of an FIB signal from the FIB apparatus or an SEM signal from a scanning electron microscope integrated in the FIB apparatus.

11. Method according to claim 1, wherein at least part of a semiconductor element, in particular of a CMOS transistor, is used as the sample.
